(19) United States
(12) Patent Application Publication
(10) Pub. No.: US 2008/0211412 A1
(43) Pub. Date: Sep. 4, 2008

(54) REMOTELY CONTROLLED LIGHT FIXTURE SYSTEM

(76) Inventor: Chi Gon CHEN, Guang Zhou (CN)

Correspondence Address: CARSTENS & CAHOON, LLP, P O BOX 802334, DALLAS, TX, 75380, US

(21) Appl. No.: 12/041,549

(22) Filed: Mar. 3, 2008

Related U.S. Application Data
(60) Provisional application No. 60/904,216, filed on Mar. 1, 2007.

(51) Int. Cl. H05B 37/02

(52) U.S. Cl. 315/152

(57) ABSTRACT

A remotely controlled LED light fixture system is disclosed. The system includes a series of light fixtures featuring LED electrically connected in series to an electrical source. In a preferred embodiment, the series of light fixtures are connected using a quick secure electro/mechanical connection. The system also includes an infrared remote receiver for receiving control signals from a remote control transmitter. The infrared remote receiver is positioned between the electrical source and the series of LED light fixtures, and controls the flow of electricity between the electrical source and the series of LED light fixtures. The remote control transmitter is configured to send a variety of different signals to the infrared remote receiver. In one embodiment the electrical source is an electrical transformer connected to standard house current. In another embodiment, the electrical source is a solar panel.

### CROSS-REFERENCE TO RELATED APPLICATION

This application claims the benefit of and priority to a U.S. Provisional Patent Application No. 60/904,216 filed Mar. 1, 2007, the technical disclosure of which is hereby incorporated herein by reference.

### BACKGROUND OF THE INVENTION

1. Technical Field of the Invention

The present invention pertains to solar powered light systems such as those primarily in close proximity to residences for the purpose of illuminating walkways or providing decorative lighting; more particularly the present invention pertains to a system for controlling the light emitted by the various lighting fixtures in a group of solar powered outdoor lights.

2. Description of the Related Art

In recent years, many homeowners have added outdoor lights to illuminate pathways or sidewalks, to guide visitors to entrances or to enhance the appearance of the residence or the surrounding landscape. Initially such outdoor light systems used house current and low wattage incandescent light bulbs. Next it was determined that low wattage, low voltage incandescent light bulbs could be used to reduce the power consumption associated with having a set of outdoor lights near a residence. Such systems required the of a voltage reduction device which reduces the voltage of house current down to the level of voltage required to cause the low wattage low voltage light bulb to illuminate.

It was then discovered that the power requirements of a low voltage, light source could be met by the electrical energy produced by a small solar panel. Accordingly, solar panels were included in individual light fixtures.

In recent years, the increase in the availability and light output of low cost light emitting diodes (LEDs) has caused the low voltage, low wattage incandescent light bulbs used in outdoor, solar powered residential home lighting systems to be replaced with an LED. Along with the use of LED came a flexibility with regard to lighting effects that could be obtained from placing multiple LEDs, possibly even of different colors into individual light fixtures. The power requirements of LEDs were such that a solar panel could be used to convert light energy into the amount of electrical energy needed to illuminate an LED.

In prior art system using low voltage, low wattage incandescent light bulbs, the only way to change the lighting effect was to disassemble each individual light fixture and change out the bulb. If less light was needed, then a lower wattage incandescent light bulb was placed in each individual light fixture. If different colors were desired, each individual incandescent light bulb had to be replaced with a light bulb emitting the desired color of light.

Such a system of replacing light bulbs each time a different lighting effect was desired has become difficult and inconvenient for home owners. Accordingly, there remains a need in the art for a system which will allow for creation of different lighting effects from a set of solar powered lighting fixtures without have to experience the inconvenience and difficulty of changing out the light bulbs in individual light fixtures.

### SUMMARY OF THE INVENTION

The system of the present invention allows for the creation of different lighting effects from a set of solar powered LED lighting fixtures and eliminates the inconvenience and difficulties associated with changing out the bulbs in individual lighting fixtures when different lighting effects are desired.

In one embodiment, the remotely controlled LED light fixture system of the present invention comprises an electrical transformer which may be connected using a standard electrical plug to house current. The transformer reduces the house current to a voltage used by the light sources in the individual light fixtures in a group of light fixtures typically used near residential structures. The system also includes a series of light fixtures electrically connected to the transformer and to one to another. In a preferred embodiment the individual light fixtures are connected to one another by means of a quick secure electro/mechanical connection. The system further includes an infrared remote receiver for receiving control signals from a remote control transmitter. The infrared remote receiver is positioned between the transformer and the series of light fixtures and controls the flow of electricity between the transformer and the series of light fixtures. The remote control transmitter is configured to send a variety of different signals to the infrared remote receiver.

In another embodiment, the source electrical energy is not from house current, but rather, is obtained from light energy that is converted by a solar collector module into electrical energy. The solar collector module includes a solar panel electrically connected to the series of light fixtures by means of electrical wire. In a preferred embodiment, the solar panel comprises a double junction amorphous solar panel arrangement. In a preferred embodiment the individual light fixtures are connected to one another by means of a quick secure electro/mechanical connection.

### BRIEF DESCRIPTION OF THE DRAWINGS

A more complete understanding of the method and apparatus of the present invention may be had by reference to the following detailed description when taken in conjunction with the accompanying drawings, wherein:

FIG. 1 is an elevation view of one embodiment of the remotely controlled LED light fixture system of the present invention;

FIG. 2 is an elevation view of a second embodiment of the remotely controlled LED light fixture system of the present invention;

FIG. 3 is a perspective view of the solar panel array of the second embodiment of the remotely controlled LED light fixture system of the present invention shown in FIG. 2;

FIG. 4A is an elevation view of a variant of the second embodiment of the remotely controlled LED light fixture system of the present invention shown in FIG. 2;

FIG. 4B is a close-up elevation view of one LED light fixture of the embodiment of the remotely controlled LED light fixture system of the present invention shown in FIG. 4A;

FIG. 4C is an exploded view of the LED light fixture shown in FIG. 4B;

FIG. 4D is a close-up exploded view of the quick secure electro/mechanical connection system of the LED light fixture shown in FIG. 4C;

FIG. 5 is a block diagram illustrating the connections between the components parts of the disclosed system which enable to remote control system of the present invention to operate; and

FIG. 6 is the three wire system of the preferred embodiment of the present invention.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

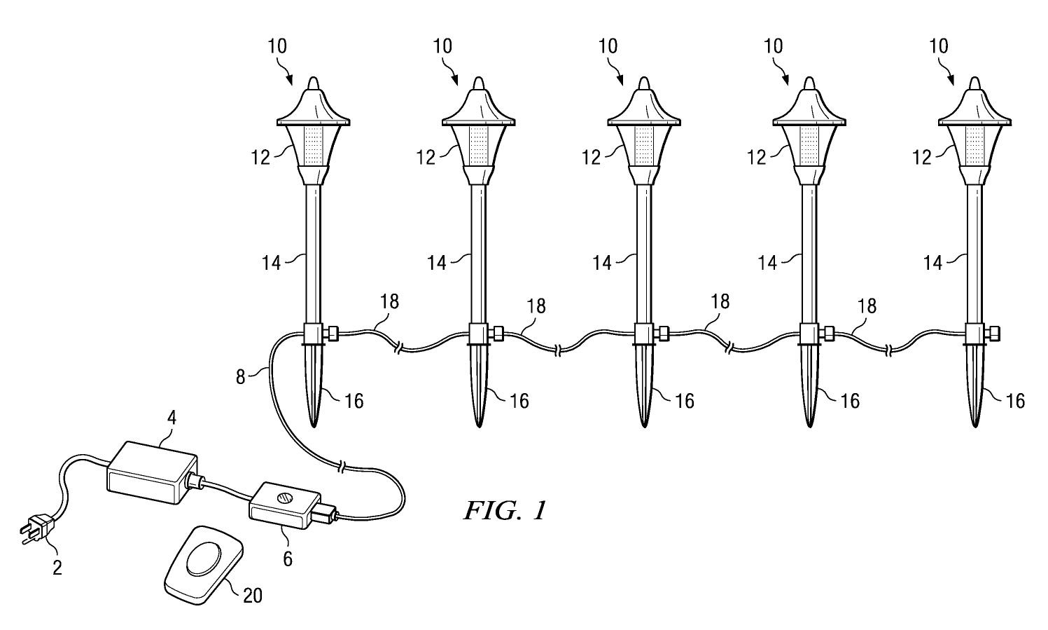

With reference to FIG. 1 an embodiment of the remotely controlled LED light fixture system of the present invention is shown. The system comprises transformer 4 which may be connected using a standard electrical plug 2 to house current for the purpose of reducing the house current to a voltage used by the light sources 12 in the individual light fixtures 10 in a group of light fixtures typically used near residential structures. The system also includes a series of light fixtures 10 electrically connected to the transformer 4 by means of electrical wire 8 and to one to another by means of electrical wire 18. In a preferred embodiment the individual light fixtures are connected to one another by means of a quick secure electro/mechanical connection, which will be disclosed in greater detail below.

Each light fixture 10 includes a ground mount element 16 for securing the fixture 10 to the ground and an elevation element 14 for elevating the light source 12 above the ground. It is noted that the elevation element 14 typically includes a conduit through which a wire carrying electrical current can access the light source 12. The light sources 12 on each light fixture 10 may comprise one or more LEDs. When multiple LEDs are included in a single light fixture 10, the multiple LEDs may be of one color, or alternatively may be of a variety of colors.

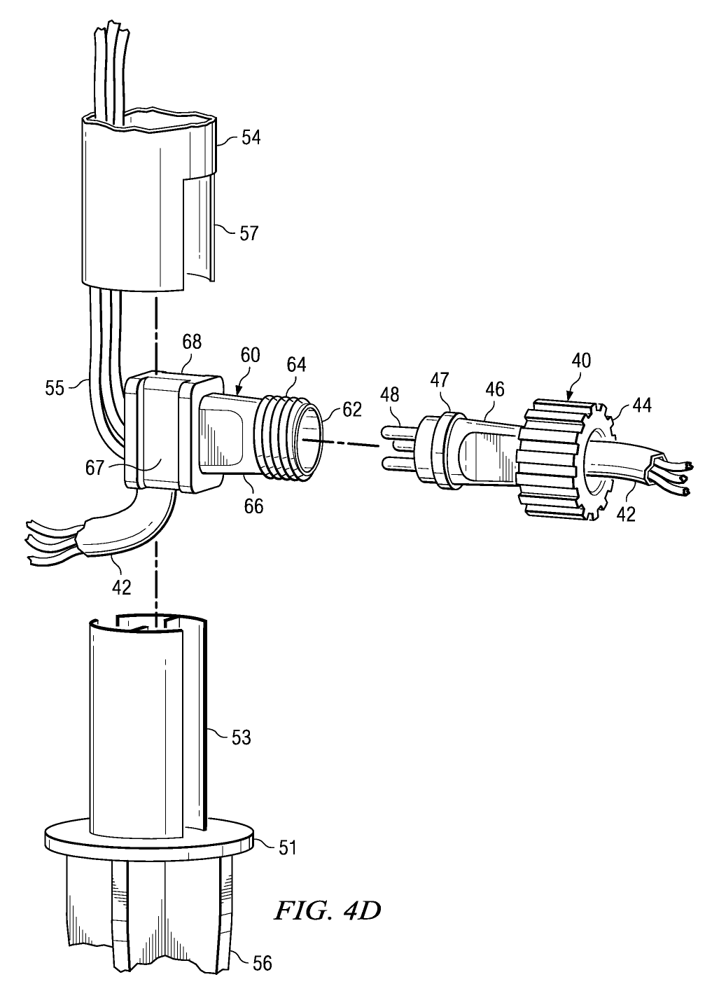

The system further includes an infrared remote receiver 6 for receiving control signals from a remote control transmitter 20. The infrared remote receiver 6 is positioned between the transformer 6 and the series of light fixtures 10 and controls the flow of electricity between the transformer 6 and the series of light fixtures 10. The remote control transmitter 20 is constructed and arranged to send a variety of different signals to the infrared remote receiver 6. As shown in FIG. 5, the remote control transmitter 20 includes an integrated control chip 23, which may be programmed to control the relative brightness and color of the individual light sources 12 through the infrared remote receiver 6. For example, the remote control transmitter 20 can signal the infrared remote receiver 6 to illuminate the individual light sources 12 at their brightest setting. Alternatively, the remote control transmitter 20 can signal the infrared remote receiver 6 to illuminate the individual light sources 12 at a medium setting. In addition, the remote control transmitter 20 can signal the infrared remote receiver 6 to illuminate only certain colored LEDs in each individual light source 12. Finally, the remote control transmitter 20 can signal the infrared remote receiver 6 to turn the individual light sources 12 off.

Practitioners of the art will quickly recognize the utility of such a system when the integrated control chip 23 is programmable such that a sequence of different lighting effects may be programmed into the remote control transmitter 20.

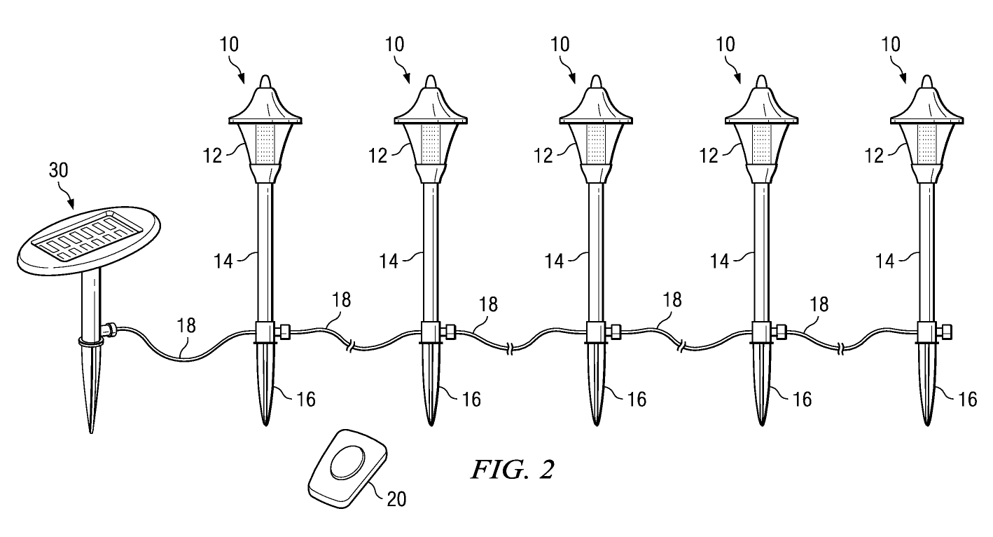

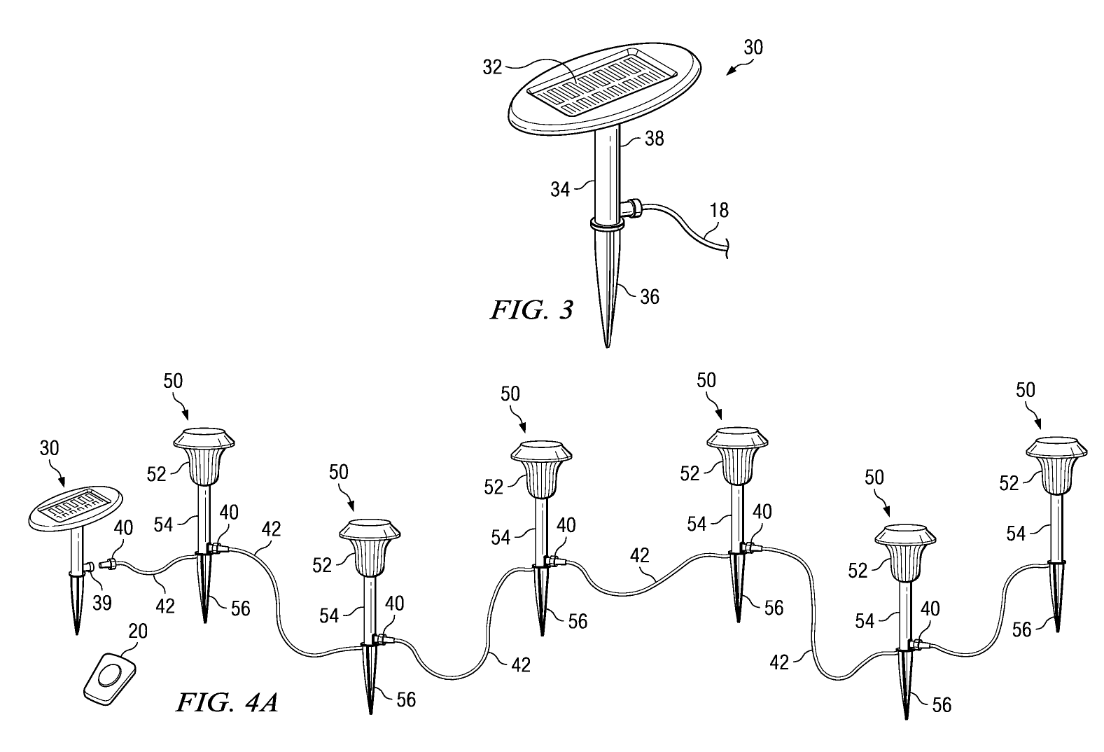

In the embodiment shown in FIG. 2, the source of electrical energy is not from house current. Rather, the source of electrical energy is obtained from light energy which is converted by a solar collector module 30 into electrical energy. As shown in FIG. 3, the solar collector module 30 includes a solar panel 32 electrically connected to the series of light fixtures 10 by means of electrical wire 18. In a preferred embodiment, the solar panel 32 comprises a double junction amorphous solar panel arrangement. Such double junction amorphous solar panels typically produce enough electrical energy to illuminate a set of lights, thus eliminating the need to incorporate a solar panel with each light fixture. The solar collector module 30 also includes a ground mount element 36 for securing the module 30 to the ground and an elevation element 34 for elevating the solar panel 32 above the ground. It is noted that the elevation element 344 typically includes a conduit through which a wire for carrying electrical current can access the solar panel 32.

In the embodiment shown in FIGS. 2 and 3, an infrared remote receiver 38 is incorporated directly into the single double junction amorphous solar panel 32 used to provide electrical power for the set of light fixtures 10. Thus, as disclosed with the previous embodiment, a remote control transmitter 20 may be used to send a variety of different signals to the infrared remote receiver 38. With additional reference to FIG. 5, the remote control transmitter 20 includes an integrated control chip 23, which may be programmed to control the relative brightness and color of the individual light sources 12 through the infrared remote receiver 6. The remote control transmitter 20 includes a 3-volt power supply 21, which powers the integrated control chip 23. Upon activation of the switch button 22, the integrated control chip 23 sends a signal through its output control 25 and infrared output device 26 to be received by the infrared remote receiver 6.

For example, the remote control transmitter 20 can signal the infrared remote receiver 6 to illuminate the individual light sources 12 at their brightest setting. Alternatively, the remote control transmitter 20 can signal the infrared remote receiver 6 to illuminate the individual light sources 12 at a medium setting. In addition, the remote control transmitter 20 can signal the infrared remote receiver 6 to illuminate only certain colored LEDs in each individual light source 12. Finally, the remote control transmitter 20 can signal the infrared remote receiver 6 to turn the individual light sources 12 off.

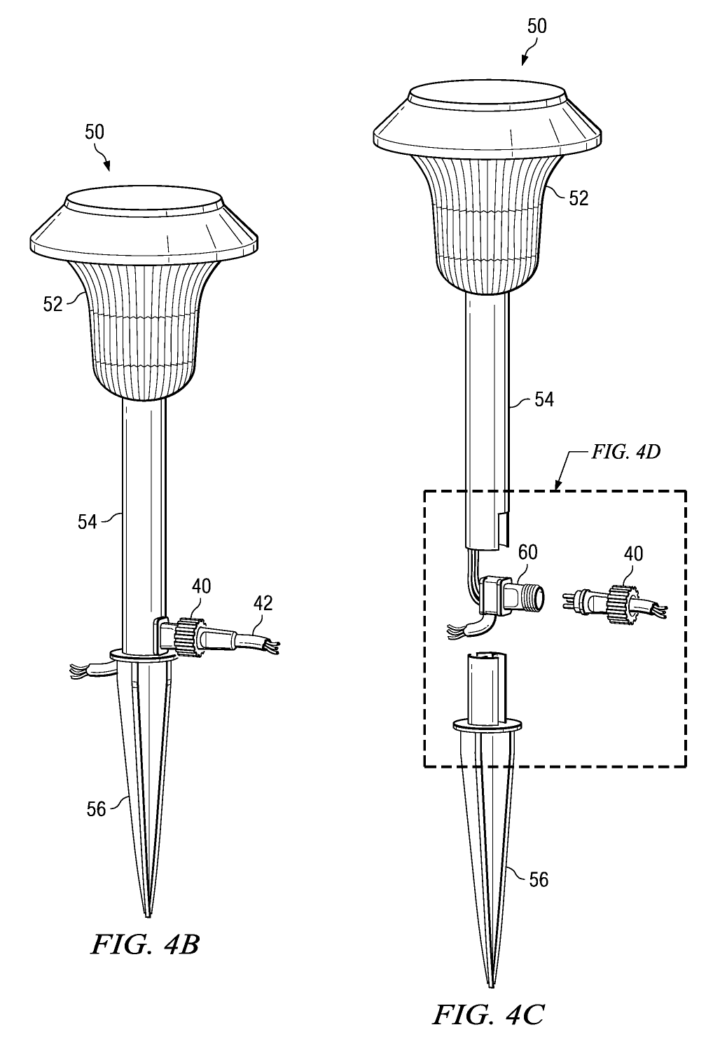

As noted previously, either of the embodiments disclosed in FIG. 1 or 2 may include a quick secure electro/mechanical connection for connecting the individual light fixtures 10 to one another. With reference now to FIGS. 4A-4D, the quick secure electro/mechanical connection, which assists in selectively connecting the light fixtures 50 one to another, is depicted. It should be noted that the quick secure connection not only connects the various light fixtures one to another electrically, but also mechanically. As shown in the Figures, the quick secure connection includes a socket 60 attached to the base of the light fixture 50. The socket 60 is configured to receive a complementary plug 40 from another light fixture 50. The socket 60 and complementary plug 40 are designed and configured form not only an electrical connection, but also a locking mechanical connection. Each light fixture 50 is an interchangeable component with the other light fixtures 50 in the overall lighting system.

Thus, each individual light fixture 50 featuring a quick secure connection comprises a ground mount element 56 for securing the fixture 50 to the ground and an elevation element 54 for elevating the light source 52 above the ground. It is noted that the elevation element 14 typically includes a conduit through which a wire carrying electrical current can access the light source 52. The light sources 52 on each light fixture 50 may comprise one or more LEDs. When multiple LEDs are included in a single light fixture 50, the multiple LEDs may be of one color, or alternatively may be of a variety of colors. Each individual light fixture 50 further includes an electrical conduit 42 hardwired to the socket base 68. The distal end of the electrical conduit 42 includes a complementary plug for attaching to another light fixture.

In a preferred embodiment of the quick secure connection shown best in FIG. 4D, the socket 60 comprises a socket base 68, which includes a slot 67 formed therein for slidably attaching to a slotted tine 53 extending from the top plate 51 of the ground mount element 56. The socket 60 is further captured by a slot 57 in the base of the elevation element 54 which slides over the socket base 68 captured in the slotted tine 53. The socket 60 also includes an extender element 66 which includes a threaded portion 64, which is configured to matingly engage threads on the interior circumference of a coupling knob 44 slidably coupled to the complementary plug 40 on another light fixture 50. A circumferential ridge 47 extending away from the plug body 46 prevents the coupling knob from slidably decoupling from the plug 40. In the depicted preferred embodiment, the complementary plug 40 includes an extender portion which includes electrical prongs 48 for making an electrical connection through an opening 62 on the socket 60 of another light fixture 50.

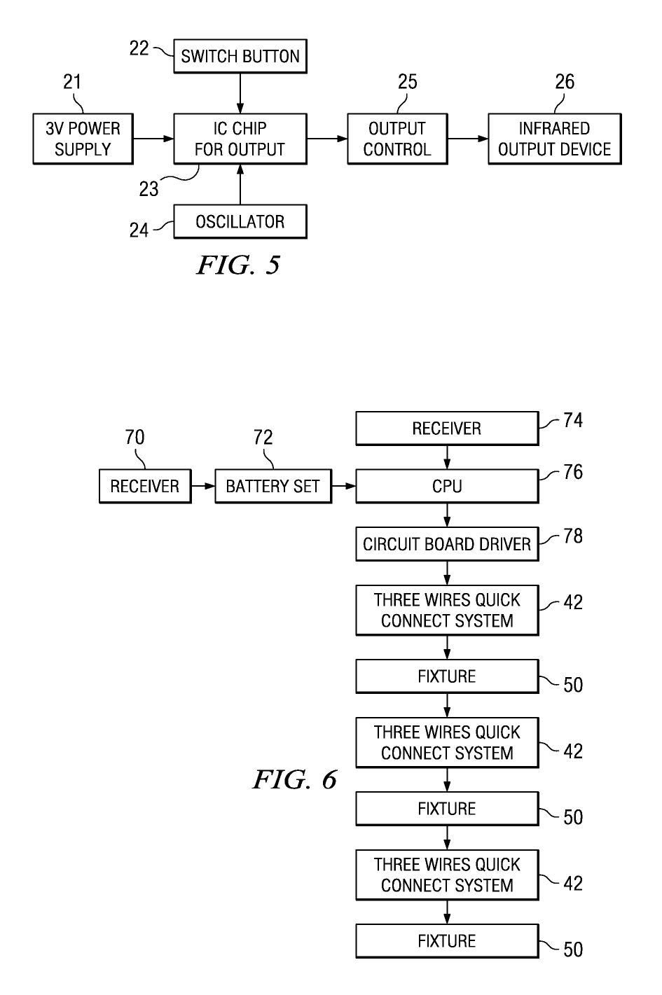

As shown in FIG. 4D, to selectively make an electrical connection using quick secure connection of the present invention, the prongs 48 extending from the plug 40 of one light fixture 50 are inserted into a complementary opening 62 in the socket 60 of another light fixture 50 completing an electrical connection. The coupling knob 44 is then threadably coupled to the threaded portion 64 of the socket 60 until the coupling knob 44 catches on the circumferential ridge 47 completing the mechanical connection. Not only is the electrical connection secure, but with proper sizing of the circumferential ridge 47 the connection can be made virtually waterproof and highly resistant to mechanical decoupling. Thus, as shown in FIG. 6, each light fixture may be connected in series to the next light fixture. Moreover, the use of a three wire system enables a multi functional, multi-color lighting system in the set of light fixtures.

It will now be evident to those skilled in the art that there has been described herein an improved remotely controlled LED light fixture system. Although the invention hereof has been described by way of a preferred embodiment, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

I claim:

1. An outdoor lighting system comprising:
a set of lighting fixtures electrically connected to one another for placement in proximity to one another in an outdoor location, wherein said set of lighting fixtures each comprise an LED light source;
a source of electrical energy electrically connected to said set of lighting fixtures;
an infrared remote receiver interposed between said source of electrical energy and said set of lighting fixtures;
an infrared remote transmitter for sending signals to said infrared remote receiver for controlling the operation of said set of lighting fixtures;
whereby said infrared remote transmitter enables operation of said set of light fixtures according to a mode selected from a group including half-bright, regular bright, maximum bright, multi-color and off.

2. The outdoor lighting system of claim 1, wherein said source of electrical energy obtains energy from a solar panel and said infrared remote receiver is included within said solar panel.

3. The outdoor lighting system of claim 1, wherein said solar panel comprises a double junction amorphous solar panel arrangement.

4. The outdoor lighting system of claim 1, further including a transformer disposed between said a source of electrical energy and said set of lighting fixtures, wherein said source of electrical energy comprises standard house current.

5. The outdoor lighting system of claim 1, wherein each of said lighting fixtures further include a quick secure connection for mechanically and electrically connecting to one another.

6. The outdoor lighting system of claim 5, wherein said quick secure connection includes a threaded electrical socket on a first lighting fixture and a complementary plug having a threaded coupling knob on a second lighting fixture.

7. The outdoor lighting system of claim 6, wherein said threaded coupling knob is slidably coupled to said complementary plug.

8. The outdoor lighting system of claim 7, wherein said complementary plug further includes a circumferential ridge extending from said plug.
